(19) United States
(12) Patent Application Publication
(10) Pub. No.: US 2002/0141559 A1
(43) Pub. Date: Oct. 3, 2002

(54) Method, apparatus, and system for selective call waiting

(76) Inventor: Burckaan Gurgun, Oakland, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/821,543

(22) Filed: Mar. 28, 2001

(51) Int. Cl. H04M 3/42

(52) U.S. Cl. 379/215.01

(57) ABSTRACT

According to one aspect of the present invention, a method is provided in which an incoming call directed to a first subscriber's communication device is received from a first caller. Upon detecting that the first subscriber's communication device is in use, it is determined whether call waiting interruption is allowed for the incoming call based upon one or more call waiting activation criteria. If call waiting interruption is allowed for the incoming call, a current user of the first subscriber's communication device is notified of the incoming call.

### FIELD OF THE INVENTION

The present invention relates generally to the field of telephone technology. More specifically, the present invention relates to an apparatus, method, and system for selective call waiting.

### BACKGROUND OF THE INVENTION

In the past several years, telephone systems and services have continued to advance rapidly in light of several technological advances and improvements with respect to telephony including Internet telephony. Phone subscribers have been able to take advantages of these enhanced services offered through phone service providers. For example, various advanced service features have been offered by various phone providers such as caller ID, call waiting, call screening, multi-way call conferencing, etc. Call waiting, for instance, is a telephone service that enables a phone subscriber to be notified of an incoming phone call even when the phone subscriber is busy talking on the phone. Usually, the notification is a brief tone that interrupts the ongoing conversation to alert the phone subscriber of the incoming phone call. The phone subscriber may decide to take the incoming call by pressing a designated button on the phone to accept the incoming call, etc. The call waiting service may also be combined with the caller ID service to let the phone subscriber check the caller ID in deciding whether to accept the incoming call. However, the conventional call waiting service or the call waiting service combined with caller ID service does not offer the phone subscriber with an ability to have control as to who should be allowed to activate call waiting. Specifically, under the conventional call waiting service currently being offered to phone subscribers by various phone providers, the phone subscribers are going to be interrupted and notified of the incoming call regardless of the caller identity and regardless of timing of the incoming call.

Accordingly, there exists a need to have a call waiting feature/service that provides the phone subscriber with more control over how call waiting service is activated.

### SUMMARY OF THE INVENTION

According to one aspect of the present invention, a method is provided in which an incoming call directed to a first subscriber's communication device is received from a first caller. Upon detecting that the first subscriber's communication device is in use, it is determined whether call waiting interruption is allowed for the incoming call based upon one or more call waiting activation criteria. If call waiting interruption is allowed for the incoming call, a current user of the first subscriber's communication device is notified of the incoming call.

### BRIEF DESCRIPTION OF THE DRAWINGS

The features and advantages of the present invention will be more fully understood by reference to the accompanying drawings, in which:

FIG. 1 is a flow diagram illustrating a conventional call waiting service;

FIG. 2 shows a block diagram of one embodiment of a system in which the teachings of the present invention are implemented;

FIG. 3 shows a block diagram of one embodiment of a switching system in which selective call waiting is implemented in accordance with the teachings of the present invention;

FIG. 4 shows a block diagram of one embodiment of a communication device capable of performing selective call waiting function in accordance with the teachings of the present invention;

FIG. 5 shows a structure diagram of one embodiment of a user profile database according to the teachings of the present invention;

FIG. 6 shows a diagram of one embodiment of a method according to the teachings of the present invention;

FIG. 7 shows a diagram of one embodiment of a method according to the teachings of the present invention;

FIGS. 8-11 illustrate one example of various interfaces that can be used by a subscriber to provision/configure his or her user profile to specify various criteria for selective call waiting.

### DETAILED DESCRIPTION

In the following detailed description numerous specific details are set forth in order to provide a thorough understanding of the present invention. However, it will be appreciated by one skilled in the art that the present invention may be understood and practiced without these specific details.

In the discussion below, the teachings of the present invention are utilized to implement a method, apparatus, and a system for selective call waiting. In one embodiment, an incoming call directed to a first subscriber's communication device is received from a first caller. Upon detecting that the first subscriber's communication device is in use, (e.g., busy), it is determined whether call waiting interruption is enabled for the incoming call based upon one or more call waiting activation criteria. In one embodiment, if call waiting interruption is enabled for the incoming call, a current user of the first subscriber's communication is notified of the incoming call. The first subscriber's communication device may comprise a wired phone (e.g., desk top phone set, etc.), a wireless phone (e.g., portable phone, cellular phone, handheld device, etc.), a computer, or any other device configured to be used as a phone, etc. In one embodiment, the one or more call waiting activation criteria may include a predetermined list of callers that is used to determine whether call waiting interruption for the incoming call is enabled. In one embodiment, the predetermined list of callers is used to specify those callers that are not allowed by the first subscriber to activate call waiting. In this case, if the first caller is one of the callers specified in the predetermined list, call waiting will not be activated for the incoming call (e.g., the current user of the first subscriber's communication device will not be notified of the incoming call). In another embodiment, the predetermined list of callers is used to specify those callers that are allowed by the first subscriber to activate call waiting. In this case, if the first caller is not one of the callers specified in the predetermined list, call waiting will not be activated for the incoming call. In yet another embodiment, the predetermined list of callers may include a set of callers that are allowed to activate call waiting and another set of callers that are not allowed to activate call waiting. In one embodiment, the one or more call waiting activation criteria may include a predetermined time frame that is used to determined whether call waiting interruption for the incoming call is enabled. In one embodiment, the predetermined time frame is used to specify a time period during which call waiting is allowed. In this case, if the time of the incoming call falls within the predetermined time frame then call waiting will be activated for the incoming call provided that other call waiting criteria are also satisfied. In another embodiment, the predetermined time frame may be used to specify a time period during which call waiting is not allowed. In this embodiment, if the time of the incoming call falls within the predetermined time frame, then call waiting will not be activated for the incoming call. The teachings of the present invention are applicable to any method, scheme, apparatus, or system for communications that has call waiting feature/service including, but not limited to, the traditional telephone system based on the public switched telephone network (PSTN) framework, the Internet telephony frame work and protocols, wireless framework and protocols, other frameworks and protocols that are used for communications, etc. Moreover, the teachings of the present invention are also applicable to any method, scheme, apparatus, or system for communications between various entities via a network (e.g., local area network, wide area network, the Internet, or any combinations thereof) in which a communication session between the various entities may need to be selectively established based on various criteria. As described herein, the teachings of the present invention can be implemented in various embodiments depending on the particular applications and usages of the invention. Each of these various embodiments may be offered as different services by the service providers or the endpoint devices (e.g., phones, PCs, wireless devices, etc.).

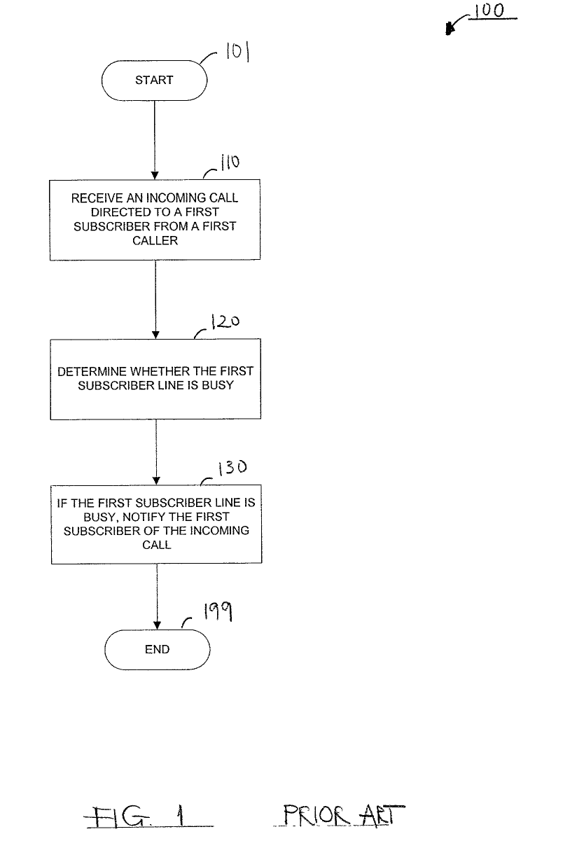

FIG. 1 shows a flow diagram illustrating a conventional call waiting service/feature process. At block 10, an incoming call directed to a first subscriber is received from a first caller. At block 120, it is determined whether the first subscriber's line is busy. At block 130, if the first subscriber's line is busy, it is determined whether the first subscriber's phone services include call waiting service/feature. At block 140, if the first subscriber has call waiting service, notify the first subscriber of the incoming call. In a conventional phone system, the notification is usually a brief tone that interrupts the ongoing conversation between the first subscriber and another party. The first subscriber may decide to take the incoming call from the first caller by pressing a designated key or button on his phone set. As discussed herein, the conventional or traditional call waiting service/feature does not provide the phone subscriber with the option or flexibility to not be interrupted. Even when the conventional call waiting service/feature is combined with caller ID service, the phone subscriber still does not have any control over whether call waiting service should be activated. Specifically, the conventional call waiting service alone or in combination with caller ID service does not give the phone subscriber the option or the ability to specify who should be allowed or disallowed to activate call waiting and when call waiting activation is allowed or disallowed.

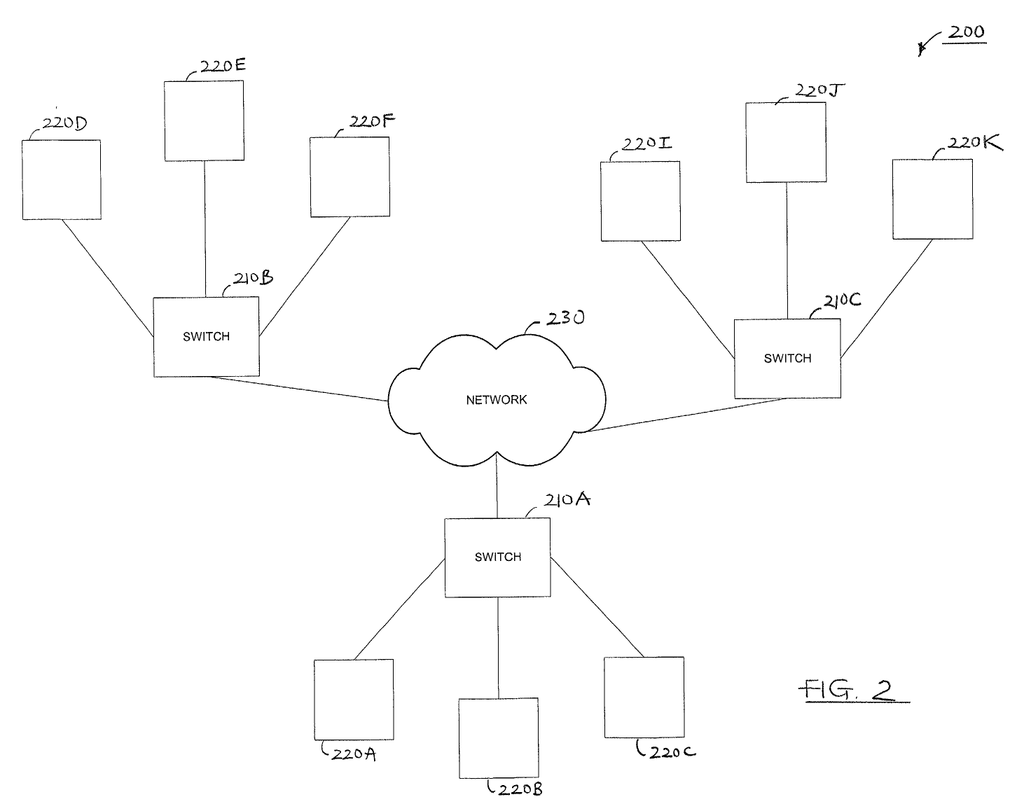

FIG. 2 shows a block diagram of one embodiment of a communications network/system in which the teachings of the present invention are implemented. As shown in FIG. 2, the system 200 includes a plurality of switches 210A-C each of which connected to a plurality of communication devices 220. The plurality of switches, in one embodiment, can be connected via a communication network 230. A communication device 200 shown in FIG. 2 may be any type of devices used for communications including traditional or conventional phone set, mobile phone, portable phone, cellular phone, IP phone, PC, etc., or any combinations thereof. The switches 210 may be traditional phone switches, private branch exchange, mobile phone switches, servers, cable head ends, other switching devices or circuits, or any combinations thereof. The network 230 can be a local area network, a wide area network, cable network, a “virtual private network”, the public switched telephone network (PSTN), the Internet, or any combinations thereof. The network 230 can also be a combination of wired and wireless networks that are configured to interconnect the various switches coupled to the network 230. In one embodiment, the various communication devices 220 can be connected to their corresponding switches via wired connection, wireless connection, or combination of wired and wireless connections. For example, in a conventional PSTN phone system, the communication devices 220 can be conventional phone sets connected via local loop to their corresponding phone switches (also called switching offices or central offices). Several central offices or phone switches can be interconnected via trunk lines. Depending upon particular implementations and/or applications of the present invention, the selective call waiting feature/service described herein according to the teachings of the present invention can be implemented either in the phone switches 210 or in the individual communication devices 220, or in any combinations thereof. For example, the selective call waiting feature/service described herein can be configured and controlled via the phone switch 220. Alternatively, the selective call waiting feature/service can be configured and controlled by the individual communication devices. For example, in one embodiment, call waiting activation criteria to be used for processing selective call waiting for a particular subscriber can be stored in a user profile associated with that particular subscriber and such a user profile can be configured and maintained in the corresponding switch to which the subscriber's communication device (e.g., phone) is connected. Alternatively, the call waiting activation criteria for the subscriber can be configured and stored with the subscriber's communication device.

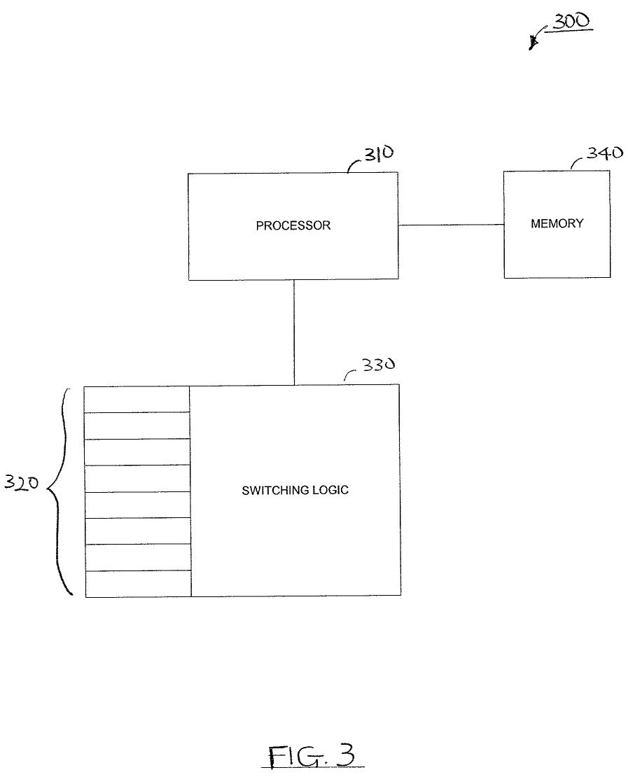

FIG. 3 shows a functional block diagram of one embodiment of a switch 300 according to the teachings of the present invention. The switch 300 includes a processor 310, a plurality of ports 320 that are connected to a plurality of communication devices (not shown), switching logic 330, and trunk lines (not shown). The switch 300 further includes a memory 340 that may be used to store user profile information associated with various subscribers and configuration information associated with individual communication devices that are connected to switch 300. In one embodiment, the processor 310 is configured to perform various functions such as controlling the communication interface between the various devices connected to the switch 300. For example, the processor 300 is responsible for directing incoming calls to the appropriate devices connected to the switch 300. In one embodiment, the processor 300 controls various service features associated with various subscribers including caller ID service, call waiting service, etc. In one embodiment, the processor 300 controls call waiting service for particular subscribers based upon the user profile information associated with the respective subscribers. For example, when an incoming call is directed to a communication device associated with a particular subscriber, the processor determines whether that particular has selective call waiting service and whether call waiting should be activated based upon call waiting activation criteria information stored in the subscriber's user profile.

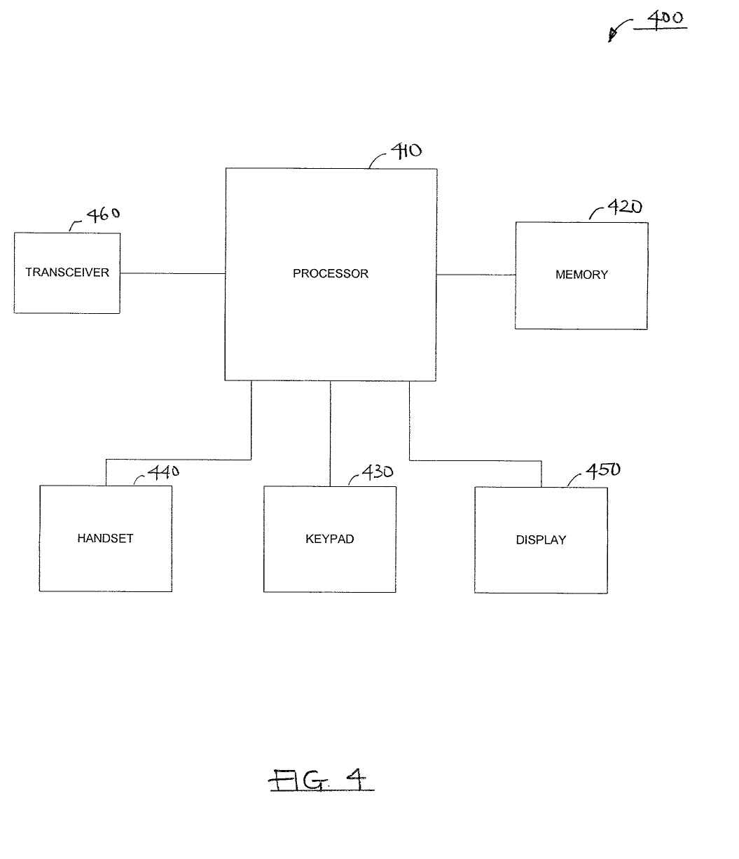

FIG. 4 illustrates a block diagram of one embodiment of a communication device 400 capable of performing selective call waiting function according to the teachings of the present invention. In one embodiment, the communication device 400 includes a processor or controller 410 to control the various functions of the communication device 400 including user profile configuration/provision, and selective call waiting activation, etc. The processor 410 is coupled to a memory 420, a keypad 430, a handset 440, a display unit 450, and a transceiver 460. In one embodiment, the handset 440 includes a speaker and a microphone that allow a user of the communication device 400 to communicate with another user. In one embodiment, the keypad 430 is designed to allow the user to configure or provision his user profile information including selective call waiting activation criteria information. In one embodiment, the memory 420 is used to store the user profile information associated with a corresponding subscriber including the call waiting activation criteria as described herein. In one embodiment, the processor 400, upon receiving an incoming call from a caller and determining that the device 400 is busy, decides whether to activate call waiting based upon call waiting activation information stored in the memory 420. Such call waiting activation criteria may include information indicating whether the subscriber has selective call waiting service included in his service options, whether the caller of the incoming call is a person allowed by the subscriber to activate call waiting feature, and whether the time of the incoming call falls within a predetermined time period in which call waiting interruption is allowed, etc.

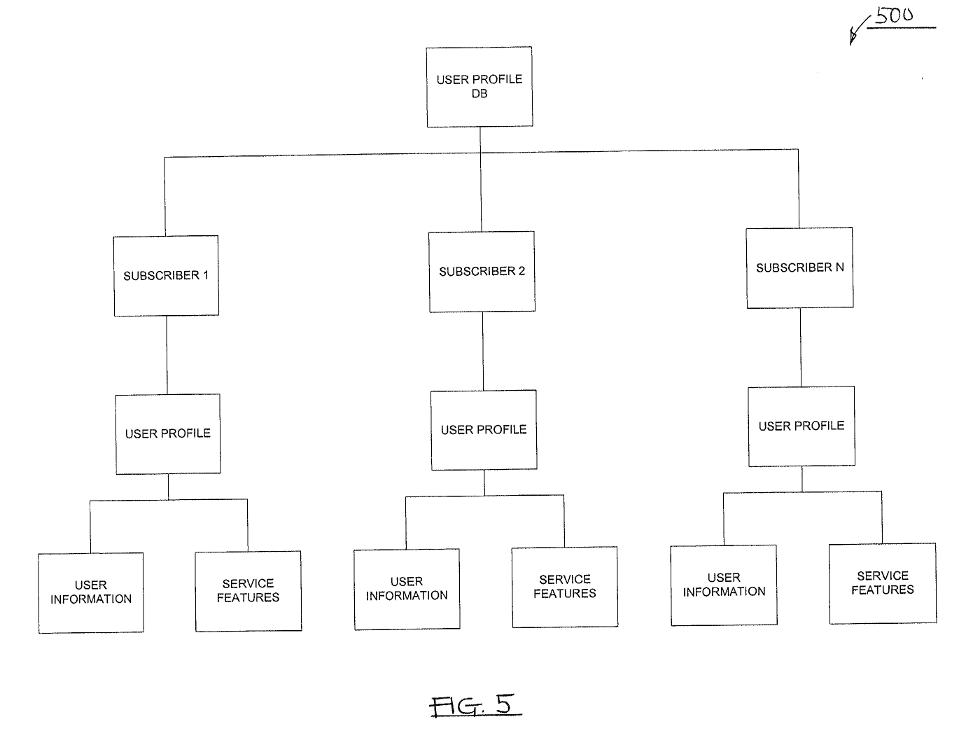

FIG. 5 shows a structure diagram of one embodiment of a user profile database 500 according to the teachings of the present invention. In one embodiment, the user profile database 500 includes a list of subscribers. Each subscriber has a user profile table or file that contains the basic subscriber information such as name and address, a list of service features subscribed by the respective subscriber, and call waiting activation criteria information provided by the respective subscriber if he has selective call waiting service. In one embodiment, the call waiting activation criteria may include a predetermined list of callers that is used to determine whether call waiting interruption for an incoming call is enabled. In one embodiment, the predetermined list of callers is used to specify those callers that are not allowed by the first subscriber to activate call waiting. In this case, if a caller is one of the callers specified in the predetermined list, call waiting will not be activated for the incoming call (e.g., the current user of the subscriber's communication device will not be notified of the incoming call). In another embodiment, the predetermined list of callers is used to specify those callers that are allowed by the subscriber to activate call waiting. In this case, if a caller is not one of the callers specified in the predetermined list, call waiting will not be activated for the incoming call. In yet another embodiment, the predetermined list of callers may include a set of callers that are allowed to activate call waiting and another set of callers that are not allowed to activate call waiting. In one embodiment, the one or more call waiting activation criteria may include a predetermined time frame that is used to determined whether call waiting interruption for the incoming call is allowed. In one embodiment, the predetermined time frame is used to specify a time period during which call waiting is allowed. In another embodiment, the predetermined time frame may be used to specify a time period during which call waiting is not allowed.

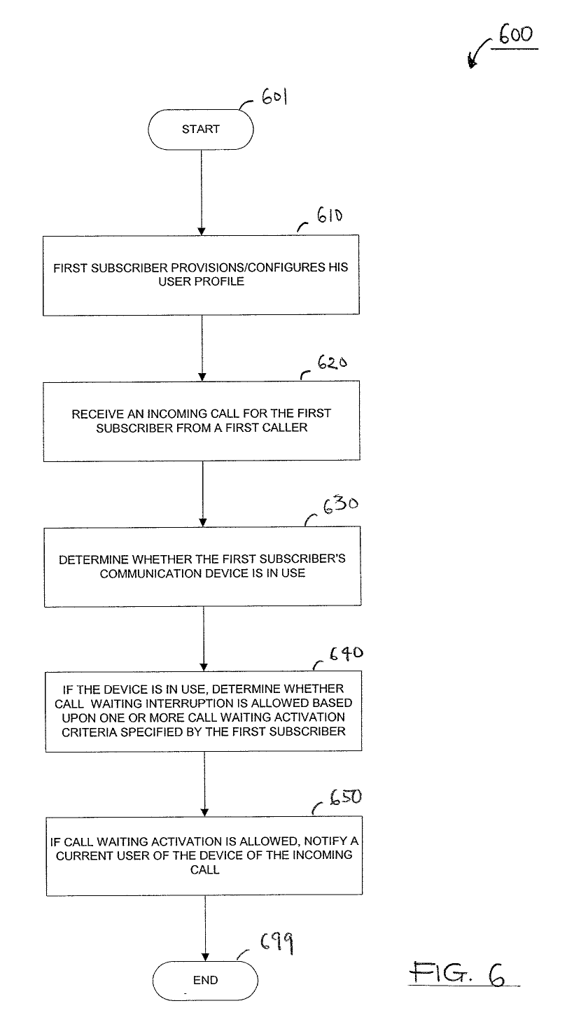

FIG. 6 shows a flow diagram of one embodiment of a method in accordance with teachings of the present invention. At block 610, a first subscriber who has subscribed to selective call waiting service provisions or configures his user profile to specify various criteria that are used for performing selective call waiting feature. The provisioning or configuration of the subscriber's user profile may be carried out in various ways depending on the particular implementations and applications of the present invention. For example, if the user profile is stored and maintained at a phone switch (e.g., switching office) to which the subscriber's phone is connected, the subscriber can use certain user interfaces such as a keypad and other programmable keys on the phone to initiate and perform the user profile configuration process to specify selective call waiting criteria. In another embodiment, the subscriber can perform the configuration process through an interactive voice response system that allows the subscriber to interface with the phone switch and configures his user profile information. In yet another embodiment, the subscriber may also perform the configuration process via the Internet. In this example, the subscriber can establish connection with the switching office or other web site designated for handling the user profile configuration. The subscriber can configure/provision his user profile information using a web browser through a CGI interface or java applet or other third party software, etc. At block 620, an incoming call for a first subscriber is received from a first caller. At block 630, it is detected whether the first subscriber's communication device is in use. At block 640, upon detecting that the first subscriber's communication is in use, it is determined whether call waiting interruption is allowed for the incoming call based upon one or more call waiting activation criteria specified by the first subscriber. As described herein, in one embodiment, such call waiting activation criteria may include a list of callers that are allowed by the first subscriber to activate call waiting feature. Alternatively, the call waiting activation criteria may include a list of callers that are not allowed by the first subscriber to activate call waiting. As described above, the call waiting activation criteria may also include a time frame specified by the first subscriber that is used to determine whether the time of the incoming call falls within a time period during which call waiting interruption is allowed by the subscriber. At block 650, if call waiting activation is allowed based upon the criteria specified by the subscriber, a current user of the subscriber's communication device is notified of the incoming call.

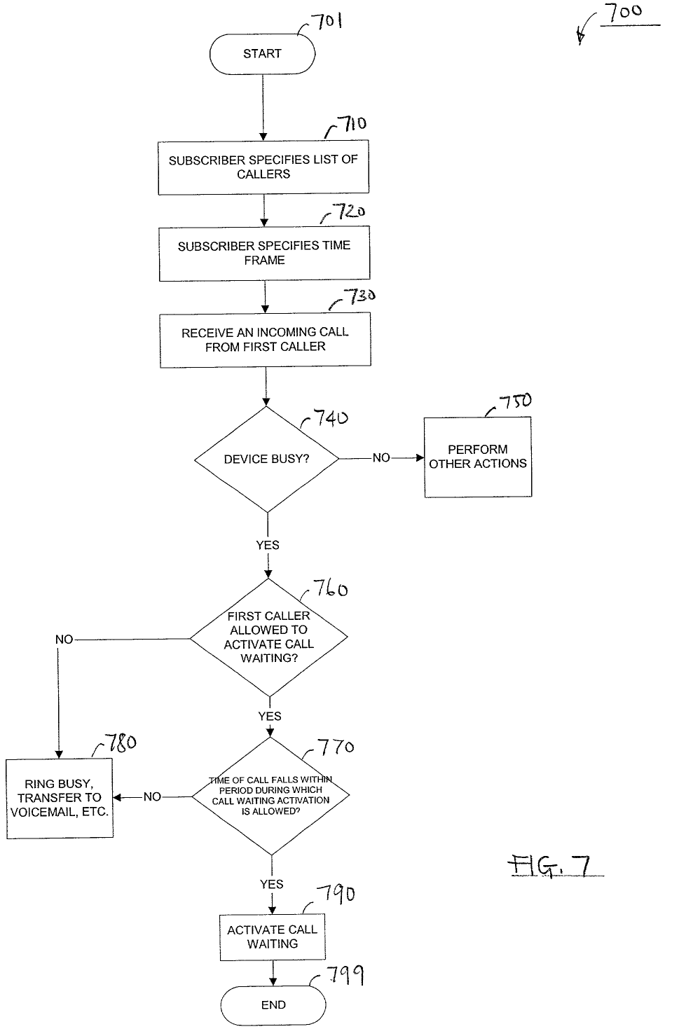

FIG. 7 shows a detailed flow diagram of one embodiment of a method according to the teachings of the present invention. At block 710, a subscriber who has subscribed to selective call waiting service configures his user profile to specify a list of callers that are allowed to activate call waiting feature. As described above, in another embodiment, the subscriber may specify a list of callers that are not allowed to activate call waiting feature. At block 720, the subscriber specifies a time frame during which call waiting activation is allowed. Alternatively, the subscriber may specify a time frame during which call waiting activation is not allowed. At block 730, an incoming call for the subscriber is received from a first caller. At decision block 740, if the subscriber's communication device (e.g., phone) is not busy, the method proceeds to block 750 to perform other appropriate functions such as ringing the phone to notify the subscriber of the incoming call. Otherwise the method proceeds to decision block 760. At decision block 760, the method proceeds to block 770 if the first caller is allowed to activate call waiting feature based upon the list of callers stored in the subscriber's user profile. Otherwise, the method proceeds to block 780. At block 770, if the time of the incoming call falls within a time period during which call waiting activation is allowed, based on the predetermined time frame stored in the user profile, then the method proceeds to block 790 to activate call waiting (e.g., generate an interruption signal to notify the subscriber of the incoming call, etc.). Otherwise the method proceeds to block 780. At block 780, because the call waiting activation criteria are not satisfied, other appropriate actions can be taken such as generating a busy signal or transferring the first caller to the subscriber voice mail, etc.

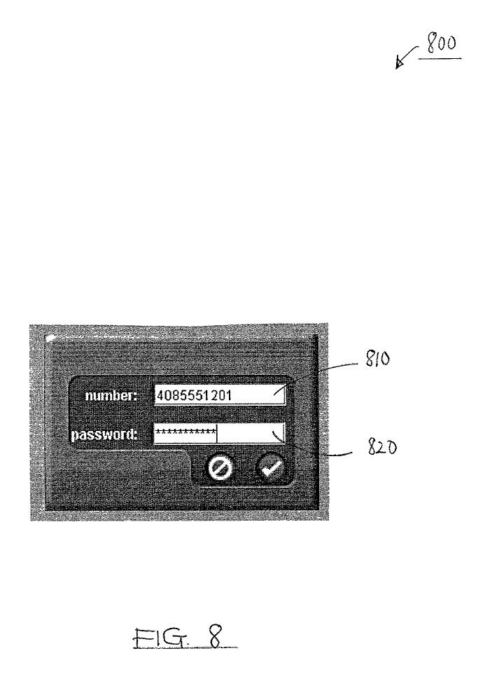

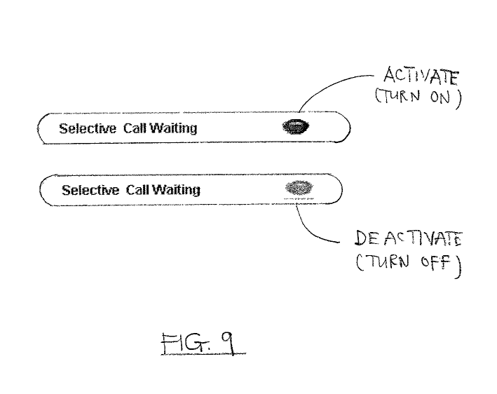

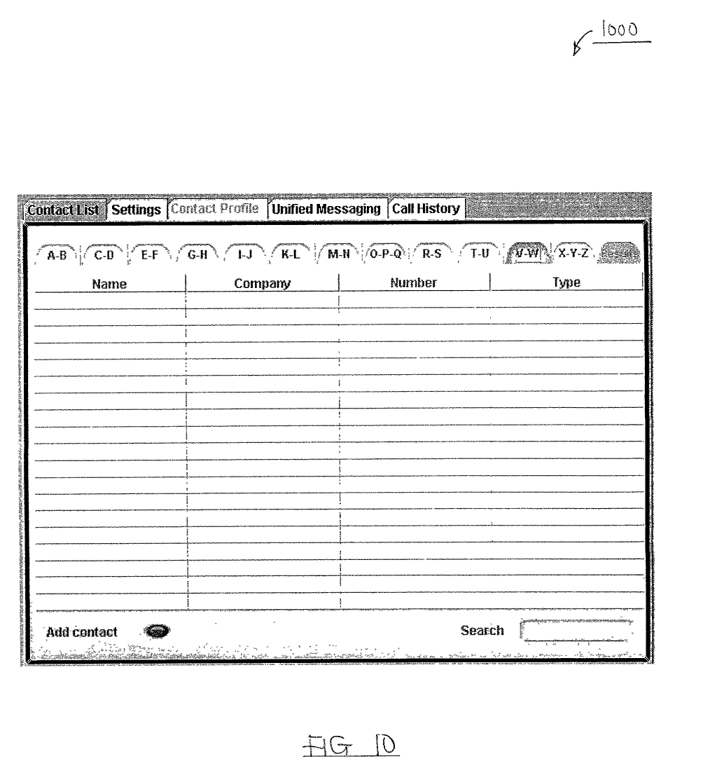

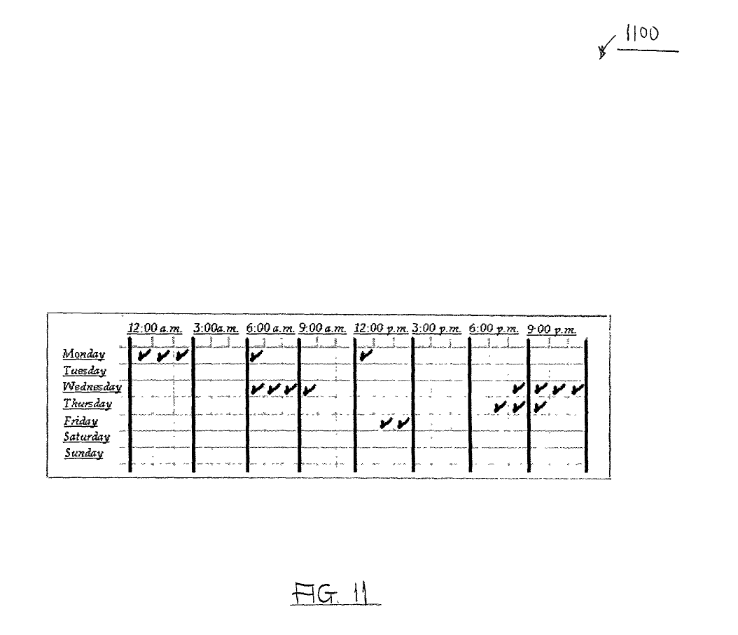

FIGS. 8-11 illustrate one example of various user interfaces that can be used by a subscriber who has subscribed to selective call waiting service to provision or configure his user profile to specify various criteria that are used for performing selective call waiting. In this example, these various user interfaces are designed and constructed as web-based interfaces. It should be understood and appreciated by one skilled in the art that these web-based interfaces are shown for the purposes of explanation and illustration and should not be construed to limit the scope of the present invention. In other embodiments, the interfaces used by the subscribers to provision their user profiles for selective call waiting may be designed and constructed differently based upon the particular applications and implementations of the teachings of the present invention. For example the provisioning or configuring of the user profiles can be done via phone interfaces, wireless device interfaces, and PC interfaces, etc. FIG. 8 shows one example of an interface 800 that is used to allow a subscriber to logon into a system to provision or modify his user profile. In one embodiment, the interface 800 includes a field 810 that can be used by the subscriber to specify his user identification (e.g., his phone number, name, or other forms of ID to identify the subscriber). In this embodiment, the logon interface 800 also includes a field 820 for the subscriber to specify his password. In this embodiment, the user ID (e.g., a phone number in this example) and the password are required for security protection (e.g., to ensure that unauthorized users will not be allowed to configure or modify the user profile information of another user). Assuming that the subscriber has successfully logon into the system, FIG. 9 shows an interface that can be used by the subscriber to activate (turn on) or deactivate (turn off) selective call waiting feature. In one embodiment, deactivating or turning off the selective call waiting feature will not affect other criteria information that are used for processing selective call waiting. For example, turning off the selective call waiting feature will not cause any loss of data or information from the list of callers or the schedule of the service activation. FIG. 10 shows an example of an interface 1000 that can be used by the subscriber to specify a list of callers that are allowed to activate call waiting. In another embodiment, the interface 1000 can be designed to enable the subscriber to specify a list of callers that are not allowed to activate call waiting. In yet another embodiment, the interface 1000 can also be designed to enable the subscriber to specify a set of callers that are allowed to activate call waiting and another set of callers that are not allowed to activate call waiting. Accordingly, the interface as shown in FIG. 10 can be designed and constructed differently depending on the specific applications and implementations of the present invention to allow the subscriber to specify a list of callers that will be used as one of the call waiting activation criteria. FIG. 11 shows an example of an interface that can be used by the subscriber to specify or select one or more time frames/periods that are used to determine whether call waiting interruption is enabled. In one embodiment, the selected time periods correspond to the time during which call waiting interruption is allowed. In another embodiment, the selected time periods can correspond to the time during which call waiting interruption is not allowed.

As described herein, the provisioning or configuration of the user profiles for selective call waiting can be done in various ways via various types of interfaces depending on the particular applications and implementations of the present invention. For example, a subscriber may use phone interfaces that may include an integrated voice response system to provision or configure his user profile. As another example, a user of a wireless device may use certain interfaces designed for wireless devices to provision or configure his user profile, etc.

The invention has been described in conjunction with the preferred embodiment. It is evident that numerous alternatives, modifications, variations and uses will be apparent to those skilled in the art in light of the foregoing description.

What is claimed is:

1. A method comprising:
receiving an incoming call from a first caller directed to a first subscriber's communication device;
upon detecting that the first subscriber's communication device is in use, determining whether call waiting interruption is enabled for the incoming call based upon one or more call waiting activation criteria; and
if call waiting interruption is enabled for the incoming call, notifying a current user of the first subscriber's communication device of the incoming call.

2. The method of claim 1 wherein the first subscriber's communication device comprises a wired phone.

3. The method of claim 1 wherein the first subscriber's communication device comprises a wireless phone.

4. The method of claim 1 wherein the first subscriber's communication device comprises a computer.

5. The method of claim 1 wherein the one or more call waiting activation criteria comprises a predetermined list of callers.

6. The method of claim 5 wherein the predetermined list of callers is used to specify those callers that are allowed by the first subscriber to activate call waiting.

7. The method of claim 5 wherein the predetermine list of callers is used to specify those callers that are not allowed by the first subscriber to activate call waiting.

8. The method of claim 5 wherein the predetermined list of callers includes a set of callers that are allowed to activate call waiting and another set of callers that are not allowed to activate call waiting.

9. The method of claim 1 wherein the one or more call waiting activation criteria comprises a predetermined time frame.

10. The method of claim 9 wherein the predetermined time frame is used to specify a time period during which call waiting is allowed.

11. The method of claim 9 wherein the predetermined time frame is used to specify a time period during which call waiting is not allowed.

12. A method comprising:
receiving a call from a first party directed to a second party's phone;
determining whether the second party's phone is busy; and
if the second party's phone is busy, determining whether to activate call waiting based upon at least one factor selected from the group consisting of a first factor indicating whether the first caller is allowed to activate call waiting and a second factor indicating whether the time of the call falls within a time period during which call waiting activation is allowed; and

13. The method of claim 12 wherein determining whether to activate call waiting comprises:
determining whether the first party is allowed to activate call waiting based upon a predetermined list of callers.

14. The method of claim 13 wherein the predetermined list of callers is used to specify those callers that are allowed to activate call waiting.

15. The method of claim 14 further comprising:
indicating that the first party is allowed to activate call waiting if the first party's identifier is found in the predetermined list of callers.

16. The method of claim 13 wherein the predetermined list of callers is used to specify those callers that are not allowed to activate call waiting.

17. The method of claim 16 further comprising:
indicating that the first party is allowed to activate call waiting if the first party's identifier is not found in the predetermined list of callers.

18. The method of claim 13 wherein the predetermined list of callers includes a set of callers that are allowed to activate call waiting and another set of callers that are not allowed to activate call waiting.

19. The method of claim 18 further comprising:
indicating that the first party is allowed to activate call waiting if the first party's identifier is found in the set of callers that are allowed to activate call waiting; and
indicating that the first party is not allowed to activate call waiting if the first party's identifier is found in the set of callers that are not allowed to activate call waiting.

20. The method of claim 13 wherein the predetermined list of callers comprises a list of caller identifiers each having a corresponding call waiting authorization indicator indicating whether the respective caller is authorized to activate call waiting, the corresponding call waiting authorization indicator being set to a first value if the respective caller is authorized to activate call waiting and being set to a second value if the respective caller is not authorized to activate call waiting.

21. The method of claim 12 wherein determining whether to activate call waiting comprises:
determining whether the time of the call falls within the time period during which call waiting activation is allowed based upon a predetermined time frame.

22. The method of claim 21 wherein the predetermined time frame corresponds to a period of time during which call waiting activation is allowed.

23. The method of claim 22 further comprising:
indicating that the time of the call falls within the time period during which call waiting activation is allowed if the time of the call falls within the predetermined time frame.

24. The method of claim 21 wherein the predetermined time frame corresponds to a period of time during which call waiting activation is not allowed.

25. The method of claim 24 further comprising:
indicating that the time of the call falls within the time period during which call waiting activation is not allowed if the time of the call falls within the predetermined time frame.

26. The method of claim 12 further comprising:
providing the second party with a mechanism to specify the predetermined list of callers.

27. The method of claim 26 wherein each caller in the predetermined list is identified by a corresponding caller identifier.

28. The method of claim 27 wherein a caller identifier comprises a phone number.

29. The method of claim 28 wherein the predetermined list of callers is stored in the second party's user profile.

30. A system for selective call waiting comprising:
logic to receive a request from a first party to establish a communication session with a second party over a network;
logic to determine whether the second party's communication device is busy; and
logic to determine, if the second party's communication is busy, whether to activate call waiting to notify the second party of the request from the first party, based upon one or more call waiting activation criteria.

31. The system of claim 30 wherein the first subscriber's communication device is selected from the group consisting of a wired phone, a wireless phone, and a computer.

32. The system of claim 30 wherein the one or more call waiting activation criteria comprises a predetermined list of callers.

33. The system of claim 32 wherein the predetermined list of callers is used to specify those callers that are allowed by the first subscriber to activate call waiting.

34. The system of claim 32 wherein the predetermine list of callers is used to specify those callers that are not allowed by the first subscriber to activate call waiting.

35. The system of claim 32 wherein the predetermined list of callers includes a set of callers that are allowed to activate call waiting and another set of callers that are not allowed to activate call waiting.

36. The system of claim 30 wherein the one or more call waiting activation criteria comprises a predetermined time frame.

37. The system of claim 36 wherein the predetermined time frame is used to specify a time period during which call waiting is allowed.

38. The system of claim 36 wherein the predetermined time frame is used to specify a time period during which call waiting is not allowed.

39. A communication device comprising:
a receiver unit to receive a request from a first party to establish a communication session with a second party;
a first database including one or more call waiting activation criteria; and
a call waiting activation unit to determine, in response to a detection that the communication device is busy, whether to activate a call waiting feature to notify the second party of the first party's request based upon the one or more call waiting activation criteria included in the first database.

40. The communication device of claim 39 wherein the one or more call waiting activation criteria comprises a predetermined list of callers.

41. The communication device of claim 40 wherein the predetermined list of callers is used to specify those callers that are allowed to activate call waiting.

42. The communication device of claim 40 wherein the predetermine list of callers is used to specify those callers that are not allowed to activate call waiting.

43. The communication device of claim 40 wherein the predetermined list of callers includes a set of callers that are allowed to activate call waiting and another set of callers that are not allowed to activate call waiting.

44. The communication device of claim 39 wherein the one or more call waiting activation criteria comprises a predetermined time frame.

45. The communication device of claim 44 wherein the predetermined time frame is used to specify a time period during which call waiting is allowed.

46. The communication device of claim 44 wherein the predetermined time frame is used to specify a time period during which call waiting is not allowed.

47. A machine-readable medium comprising instructions which, when executed by a machine, cause the machine to perform operations comprising:
receiving a call from a first party directed to a second party's phone;
determining whether the second party's phone is busy; and
if the second party's phone is busy, determining whether to activate call waiting based upon at least one factor selected from the group consisting of a first factor indicating whether the first caller is allowed to activate call waiting and a second factor indicating whether the time of the call falls within a time period during which call waiting activation is allowed; and

48. The machine-readable medium of claim 47 wherein determining whether to activate call waiting comprises:
determining whether the first party is allowed to activate call waiting based upon a predetermined list of callers.

49. The machine-readable medium of claim 48 wherein the predetermined list of callers is used to specify those callers that are allowed to activate call waiting.

50. The machine-readable medium of claim 48 wherein the predetermined list of callers is used to specify those callers that are not allowed to activate call waiting.

51. The machine-readable medium of claim 48 wherein the predetermined list of callers comprises a list of caller identifiers each having a corresponding call waiting authorization indicator indicating whether the respective caller is authorized to activate call waiting, the corresponding call waiting authorization indicator being set to a first value if the respective caller is authorized to activate call waiting and being set to a second value if the respective caller is not authorized to activate call waiting.

52. The machine-readable medium of claim 47 wherein determining whether to activate call waiting comprises:
determining whether the time of the call falls within the time period during which call waiting activation is allowed based upon a predetermined time frame.

53. The machine-readable medium of claim 52 wherein the predetermined time frame corresponds to a period of time during which call waiting activation is allowed.

54. The machine-readable medium of claim 52 wherein the predetermined time frame corresponds to a period of time during which call waiting activation is not allowed.

55. A machine-readable medium comprising instructions which, when executed by a machine, cause the machine to perform operations comprising:
receiving an incoming call from a first caller directed to a first subscriber's communication device;
upon detecting that the first subscriber's communication device is in use, determining whether call waiting interruption is enabled for the incoming call based upon one or more call waiting activation criteria; and
if call waiting interruption is enabled for the incoming call, notifying a current user of the first subscriber's communication device of the incoming call.

56. The machine-readable medium of claim 55 wherein the one or more call waiting activation criteria comprises a predetermined list of callers.

57. The machine-readable medium of claim 56 wherein the predetermined list of callers is used to specify those callers that are allowed by the first subscriber to activate call waiting.

58. The machine-readable medium of claim 56 wherein the predetermine list of callers is used to specify those callers that are not allowed by the first subscriber to activate call waiting.

59. The machine-readable medium of claim 55 wherein the one or more call waiting activation criteria comprises a predetermined time frame.

60. The machine-readable medium of claim 59 wherein the predetermined time frame is used to specify a time period during which call waiting is allowed.

61. The machine-readable medium of claim 59 wherein the predetermined time frame is used to specify a time period during which call waiting is not allowed.
